(19) United States
(12) Patent Application Publication
(10) Pub. No.: US 2026/0197119 A1
(43) Pub. Date: Jul. 9, 2026

(54) REPETITION BASED TRANSMISSION FOR JOINT SENSING AND COMMUNICATION (JAC)

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US); Tianyang BAI, Mountain View, CA (US)

(21) Appl. No.: 19/135,365

(22) PCT Filed: Feb. 23, 2023
(86) PCT No.: PCT/CN2023/077826

§ 371 Date: Jun. 3, 2025

(51) Int. Cl. H04L 1/08; H04W 72/04

(52) U.S. Cl. CPC H04L 1/08; H04W 72/04

(57) ABSTRACT

An example method of repetition-based joint sensing and communication (JSC) for sensing a target performed by a scheduling device may comprise receiving a request for a repetition-based JSC transmission. The method may also comprise responsive to the request, transmitting a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The method may further comprise transmitting or receiving the repetition-based JSC transmission based on the RF signal.

### BACKGROUND

### 1. Field of Disclosure

The present disclosure relates generally to the field of radio frequency (RF)-based sensing, or simply “RF sensing” in a wireless network such as a cellular network.

### 2. Description of Related Art

Sensing of devices can have a wide range of consumer, industrial, commercial, military, and other applications. The position of a device can be estimated based on information gathered using different sensing technologies. For example, cellular networks such as fifth-generation (5G) new radio (NR) cellular networks can be used to determine the position of wireless devices, such as user equipments (UEs) and are expanding into RF sensing to be able to detect objects (including their location and speed) from reflections (or echoes) of RF signals reflecting from the objects, and to monitor the environment, e.g., motion detections, security or gesture control.

### BRIEF SUMMARY

An example method of repetition-based joint sensing and communication (JSC) for sensing a target performed by a scheduling device may comprise receiving a request for a repetition-based JSC transmission. The method may also comprise responsive to the request, transmitting a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The method may further comprise transmitting or receiving the repetition-based JSC transmission based on the RF signal.

An example method of repetition-based joint sensing and communication (JSC) for sensing a target performed by a UE may comprise receiving, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The method may also comprise sensing the target based on the RF signal in accordance with the repetition-based sensing configuration.

An example scheduling device for repetition-based joint sensing and communication (JSC) for sensing a target comprise a transceiver; a memory; and one or more processors communicatively coupled with the transceiver and the memory. The one or more processors may be configured to receive a request for a repetition-based JSC transmission. The one or more processors may also be configured to responsive to the request, transmit a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The one or more processors may further be configured to transmit or receive the repetition-based JSC transmission based on the RF signal.

An example UE for repetition-based joint sensing and communication (JSC) for sensing a target comprise a transceiver; a memory; and one or more processors communicatively coupled with the transceiver and the memory. The one or more processors may be configured to receive, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The one or more processors may also be configured to sense the target based on the RF signal in accordance with the repetition-based sensing configuration.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 is diagram of a fifth-generation new radio (5G NR) network, according to an embodiment.

FIG. 3 is a time diagram illustrating an example slot usage of multi-segment-based repetitions and associated terminology.

FIGS. 4A-4B are flow diagrams illustrating how repetition-based joint sensing and communication (JSC) for sensing a target may be used within a wireless network, according to an embodiment.

FIG. 5 is a time diagram illustrating an example slot usage of a RF signal with non-uniform patterned repetitions that may be used by embodiments herein.

FIGS. 6A-6B are flow diagrams illustrating how repetition-based JSC for sensing a target may be used within a wireless network, according to another embodiment.

FIG. 7 is a flow diagram of a method of repetition-based JSC for sensing a target performed by a scheduling device, according to an embodiment.

FIG. 8 is a flow diagram of method of repetition-based JSC for sensing a target performed by a UE, according to an embodiment.

FIG. 9 is a block diagram of an embodiment of a base station.

FIG. 10 is a block diagram of an embodiment of a UE.

FIG. 11 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

Various aspects relate generally to RF sensing. Some aspects more specifically relate to JSC using 5G NR networks. In some examples, repetitions used in 5G NR networks' physical layer traffic scheduling are leveraged for performing time of arrival (TOA)-based sensing (e.g., similar to the pulse-based sensing). As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “positioning reference signals,” “reference signals for positioning,” and the like may be used to refer to signals used for positioning of a mobile device, such as a user equipment (UE) in a 5G new radio (NR) network. As described in more detail herein, such signals may comprise any of a variety of signal types but may not necessarily be limited to a Positioning Reference Signal (PRS) as defined in relevant wireless standards. Additionally, unless otherwise specified, references to “sensing reference signals,” “reference signals for sensing,” and the like may be used to refer to signals used for RF sensing (also generically referred to herein as “sensing”) as described herein. A signal used for RF sensing and/or positioning may be generally referred to herein as a reference signal (RS). As described in more detail herein, such signals may comprise any of a variety of signal types but may not necessarily be limited to signals solely used for RF sensing.

Besides performing communications, cellular networks, such as 5G NR networks can also be used for other wireless functions such as positioning and sensing. For example, existing JSC techniques incorporate the sensing functions to the communication system. In some existing JSC solutions, the resources used for sensing and communication are multiplexed in half duplex (e.g., using time division multiplexing (TDM) and/or frequency division multiplexing (FDM)). However, as the sensing takes up a portion of the resources that could be used for communication, the multiplexing negatively impacts the communication efficiency of the system. In some other existing JSC solutions, a single waveform is designed for both sensing and communication. However, the computational complexity would be high for accurately extracting the sensing information and enhancing the sensing performance would degrade the communication performance in those JSC solutions.

In 5G NR networks' physical layer traffic scheduling, repetitions in data traffic (e.g., the physical downlink shared channel (PDSCH) for downlink traffic, and the physical uplink shared channel (PUSCH) for uplink traffic) are widely configured to compensate for any potential coverage degradation between the transmitting device and the receiving device (e.g., to improve the cell edge coverage) and to reduce the latency.

Particular aspects of the subject matter described in this disclosure can be implemented to realize one or more of the following potential advantages. In some examples, by leveraging the repetitions in the data traffic and allowing performing time of arrival (TOA)-based sensing using the repetitions (e.g., similar to the pulse-based sensing), the described techniques could allow reuse of the existing resource used for data traffic without requiring additional resource being assigned for sensing, and the computational complexity for sensing (e.g., determining sensing measurements based on cross-correlation of the selected repetitions) in the described techniques can be low. Additional details will be provided after a discussion of applicable technology.

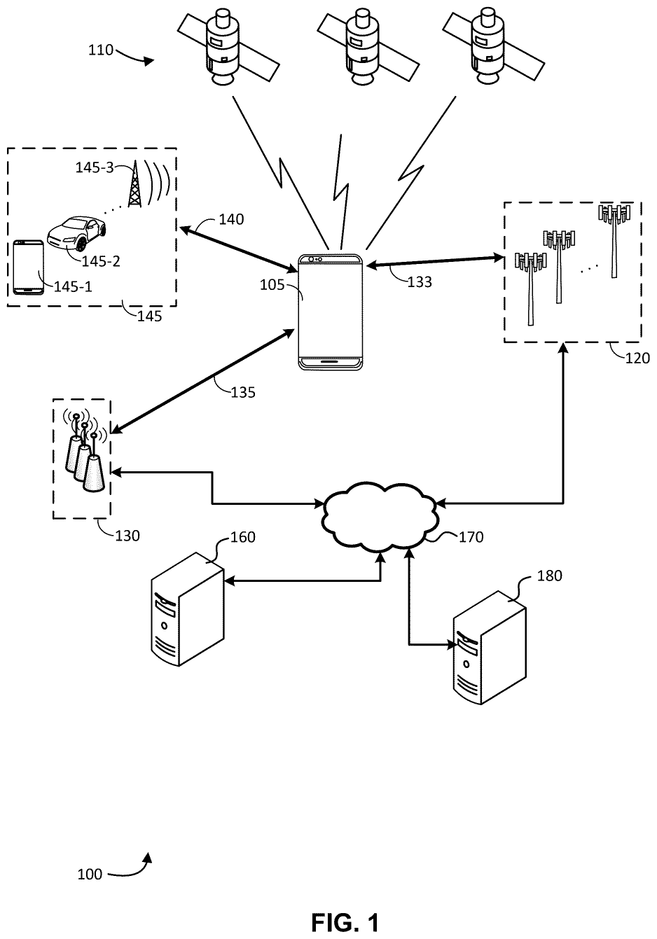

FIG. 1 is a simplified illustration of a wireless system capable of communication, positioning, and sensing, referred to herein as a “communication/positioning/sensing system” 100 in which a mobile device 105, network function server 160, and/or other components of the communication/positioning/sensing system 100 can use the techniques provided herein for RF sensing, according to an embodiment. (That said, embodiments are not necessarily limited to such a system.) The techniques described herein may be implemented by one or more components of the communication/positioning/sensing system 100. The communication/positioning/sensing system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning/sensing system 100 may be capable of enabling communication between the mobile device 105 and other devices, positioning of the mobile device 105 and/or other devices, performing RF sensing by the mobile device 105 and/or other devices, or a combination thereof. For example, the communication/positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/sensing system 100. Similarly, the communication/positioning/sensing system 100 may include a larger or smaller number of base stations 120 and/or APs 130 than illustrated in FIG. 1. The illustrated connections that connect the various components in the communication/positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions, and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an OFDM waveform to allow both RF sensing and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

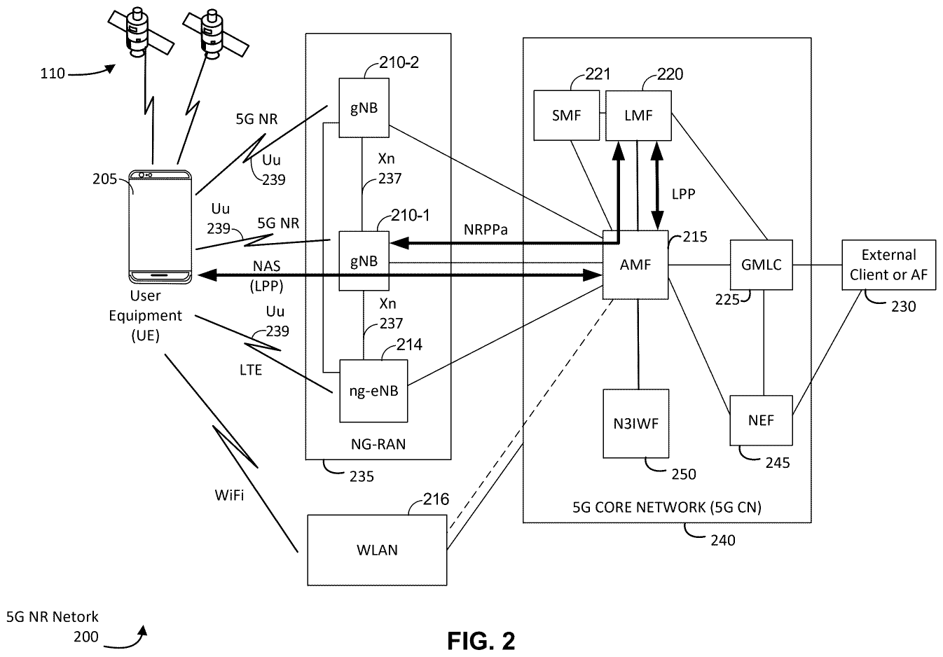

As previously noted, the example communication/positioning/sensing system 100 can be implemented using a wireless communication network, such as an LTE-based or 5G NR-based network, or a future 6G network. FIG. 2 shows a diagram of a 5G NR network 200, illustrating an embodiment of a wireless system (e.g., communication/positioning/sensing system 100) implemented in 5G NR. The 5G NR network 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR network 200 additionally may be configured to determine the location of a UE 205 by using an LMF 220 (which may correspond with location server 160) to implement the one or more positioning methods. The SMF 221 may coordinate RF sensing by the 5G NR network 200. Here, the 5G NR network 200 comprises a UE 205, and components of a 5G NR network comprising a Next Generation (NG) Radio Access Network (RAN) (NG-RAN) 235 and a 5G Core Network (5G CN) 240. A 5G NR network 200 may also be called a 5G network and/or an NR network; NG-RAN 235 may be referred to as a 5G RAN or as an NR RAN; and 5G CN 240 may be referred to as an NG Core network. Additional components of the 5G NR network 200 are described below. The 5G NR network 200 may include additional or alternative components.

The 5G NR network 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR network 200. Similarly, the 5G NR network 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR network 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235 e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR network 200, such as the LMF 220 and AMF 215.

5G NR network 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR network 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

In 5G NR networks' physical layer traffic scheduling (e.g., used through Uu interface 239 of FIG. 2), repetitions in data traffic (e.g., the PDSCH for downlink traffic, and the PUSCH for uplink traffic) are widely configured to compensate for any potential coverage degradation between the transmitting device and the receiving device (e.g., to improve the cell edge coverage) and to reduce the latency. The data traffic to and from an application is communicated via transport block (TB) packets (also referred as “TB”) over respective channel(s). In mini-slot-based repetitions, two or more repetitions of a TB can be transmitted in one slot or across the slot boundary of consecutive available slots. In multi-segment transmission, two or more repetitions of a TB can be transmitted in consecutive available slots with only one repetition in each slot and with possibly different starting symbols and/or durations.

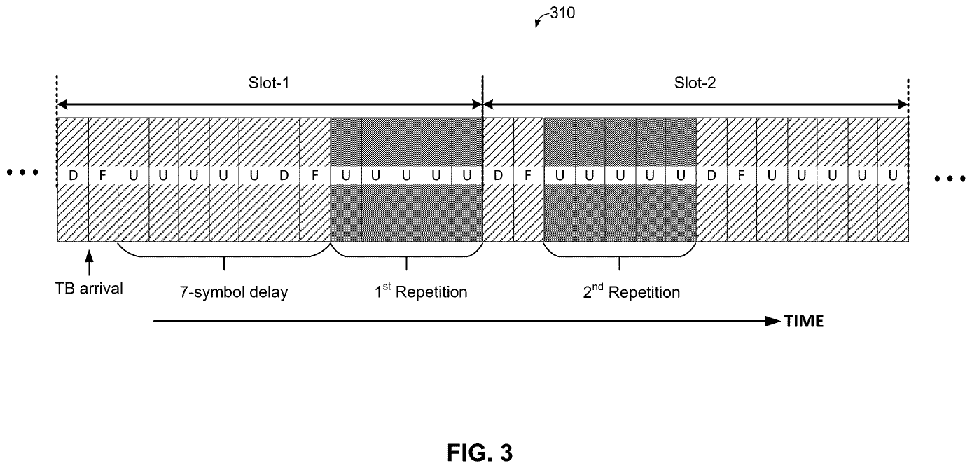

For example, FIG. 3 is a time diagram illustrating an example slot usage of multi-segment-based repetitions in a RF signal 310 and associated terminology. RF signal 310 may be used in multi-segment transmission mentioned above and may be used for uplink transmission, downlink transmission, and/or sidelink transmission. As shown in FIG. 3, the first repetition and the second repetition each includes five uplink symbols (denoted by “U” in FIG. 3) and are transmitted in two consecutive slots (e.g., slot-1 and slot-2 respectively). As noted above, the first repetition and the second repetition have the same symbol allocation in each slot but may have different starting symbols (e.g., as shown in FIG. 3, each of the first repetition and the second repetition starts with a symbol “F” denoting “flexible”, namely each of the first repetition and the second repetition could start with an uplink symbol denoted by “U” or a downlink symbol denoted by “D”) and/or can have different durations.

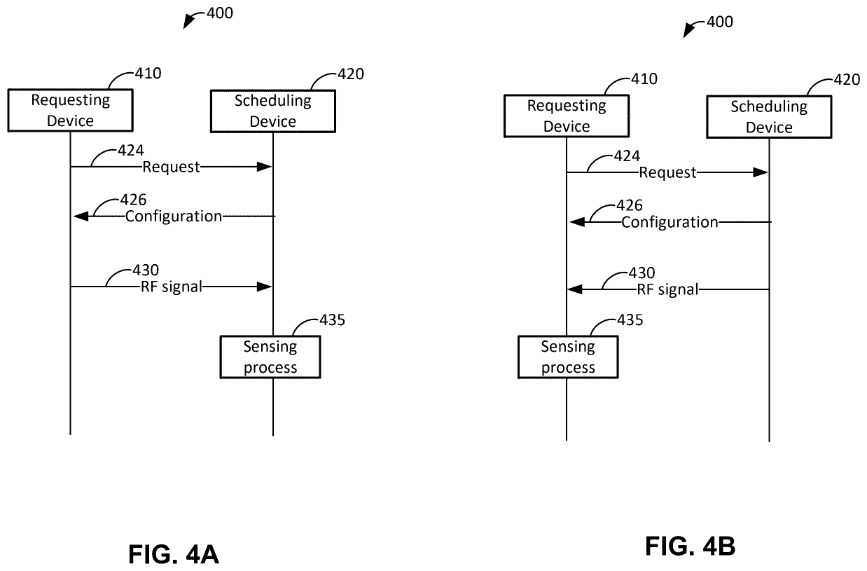

As noted above, the technical solutions disclosed herein can leverage the repetitions in the data traffic for sensing (e.g., detecting objects including their location and speed) from reflections (or echoes) of RF signals reflecting from the objects in a manner similar to pulse-based sensing (e.g., determining sensing measurements based on a correlation of the repetitions of the received RF signals). For example, FIGS. 4A-4B are flow diagrams illustrating how repetition-based joint sensing and communication (JSC) 400 for sensing a target may be used within a wireless network, according to an embodiment.

In some embodiments, repetition-based JSC 400 may be performed between a requesting device 410 and a scheduling device 420. For example, requesting device 410 may send a request for performing the repetition-based JSC transmission to a scheduling device 420, and scheduling device 420 may respond by providing a repetition-based sensing configuration that schedules the repetition-based JSC transmission. In some embodiments, as shown in FIG. 4A, requesting device 410 may transmit the configured RF signal (e.g., physical PUSCH signals) to scheduling device 420 for determining the sensing measurements (e.g., determining TOA measurements and or phase difference based on the repetitions of the received RF signal). Alternatively, as shown in FIG. 4B, scheduling device 420 may transmit the configured RF signal (e.g., physical PDSCH signals) to requesting device 410 for determining the sensing measurements. In some embodiments, requesting device 410 may correspond with mobile device 105 of FIG. 1 or UE 205 of FIG. 2 and scheduling device 420 may correspond with base stations 120 of FIG. 1.

As shown in FIGS. 4A and 4B, starting from arrow 424, requesting device 410 may transmit a request for performing the repetition-based JSC transmission (e.g., from an application, or “app,” executed by requesting device 410), and the repetition-based sensing may be UE-based.

At arrow 426, a repetition-based sensing configuration may be determined by scheduling device 420 for configuring RF signals used for the repetition-based JSC transmission and may be transmitted to requesting device 410 for performing the repetition-based JSC transmission. In some embodiments, in accordance with the repetition-based sensing configuration, the RF signal may include a plurality of repetitions (e.g., as shown in FIG. 3). In some embodiments, the repetition-based sensing configuration may indicate at least a subset of repetitions of the plurality of repetitions used for sensing and may indicate the phase continuity status of at least some of the plurality of repetitions of the RF signal.

In some embodiments, each repetition of the plurality of repetitions of the RF signal may be indexed according to a redundancy version (RV) of the respective repetition (e.g., a RV index associated with each repetition), and repetitions having a same redundancy version may be indexed into a same group. In some embodiments, the repetition-based sensing configuration may indicate the repetitions used for sensing based on any repetitions of the subset of repetitions, repetitions that belong to the same group (e.g., only repetitions having a same redundancy version may be used for sensing), repetitions within a same slot of the RF signal, or any combination thereof.

At arrow 430, a RF signal configured according to the repetition-based sensing configuration may be transmitted between requesting device 410 and scheduling device 420 for sensing. For example, as shown in FIG. 4A, in PUSCH-based sensing, requesting device 410 may transmit the RF signal to scheduling device 420. Accordingly, in block 435 shown in FIG. 4A, scheduling device 420 may perform the RF sensing based on the received RF signal (will be discussed in detail below). Alternatively, in PDSCH-based sensing, as indicated in FIG. 4B, scheduling device 420 may transmit the RF signal to requesting device 410. Accordingly, in block 435 shown in FIG. 4B, requesting device 410 may perform the RF sensing based on the received RF signal.

At block 435, a sensing process may be performed. For example, during the sensing process, as noted above, a transmitting device (e.g., requesting device 410 in PUSCH-based sensing as shown in FIG. 4A or scheduling device 420 in PDSCH-based sensing as shown in FIG. 4B) may transmit the RF signals. A receiving device (e.g., scheduling device 420 in PUSCH-based sensing as shown in FIG. 4A or requesting device 410 in PDSCH-based sensing as shown in FIG. 4B) may buffer samples of the subset of repetitions indicated in the repetition-based sensing configuration for calculating the correlation of subset of repetitions similar to pulse-based sensing. Reflection or echoes of the RF signals reflected by a target to be sensed may be received by the receiving device, where sensing measurements may be determined based on a correlation of subset of repetitions of the received RF signals similar to a pulse-based sensing.

In some embodiments, as shown in FIGS. 4A and 4B (e.g., prior to transmitting the RF signal at arrow 430), the repetition-based sensing configuration may be transmitted based on radio resource control (RRC) signaling prior to the transmission of the plurality of repetitions of the RF signal. Additionally or alternatively, in some embodiments, the repetition-based sensing configuration may be transmitted along with the plurality of repetitions of the RF signal (e.g., after the transmission of at least one repetition of the plurality of repetitions and before one or more repetitions of the subset of repetitions used for sensing) based on media access control (MAC) control elements, or downlink control information (DCI). For example, the repetition-based sensing configuration (e.g., using one or more bits to indicate whether the following one or more repetitions can be used for sensing with one or more previously transmitted repetitions (e.g., be associated with the previously transmitted repetitions for calculating the correlation)) may be transmitted prior to the transmission of the specific repetition that is used for sensing (e.g., transmitted immediately before such repetition). In some embodiments, the repetition-based sensing configuration may also indicate the phase continuity of the following one or more repetitions (e.g., the adjacent repetitions can be used for sensing when the phase continuity is enabled).

In hybrid automatic repeat request (HARQ) settings where multiple negative acknowledgements (NACK) may be transmitted by a receiving device in response to unsuccessful reception of one or more of the plurality of repetitions, in some embodiments, the NACK transmitted by the receiving device may be used as part of the repetition-based sensing configuration for indicating whether the associated repetition (e.g., the repetition immediately transmitted next to (e.g., ahead of and/or behind) the NACK) may be used for sensing.

In some embodiments, the repetition-based sensing configuration may be determined based on a capability of requesting device 410. For example, in PDSCH signal transmission, prior to determining the repetition-based sensing configuration, requesting device 410 may transmit a capability report indicating whether requesting device 410 supports the repetition-based sensing, a maximum length of repetitions that can be buffered by the requesting device, or any combination thereof. Additionally or alternatively, in PUSCH signal transmission, the capability report may indicate whether to have a phase continuity among the subset of repetitions.

In some embodiments, the capability report may be included in the request for performing the repetition-based JSC transmission (also referred as “the repetition-based JSC transmission request”) and is transmitted in arrow 424.

In some embodiments, the repetition-based sensing configuration may also be determined based on a repetition distribution pattern proposed by requesting device 410. For example, the repetition-based JSC transmission request may indicate the granularity or accuracy requirement of the sensing which may be determined based on a density of the subset of repetitions of the RF signal (e.g., the time spacing between the repetitions). In some embodiments, the repetition-based JSC transmission request may also include parameters indicating a duration of each repetition in the subset of repetitions, a number of repetitions in the subset of repetitions, a redundancy version of repetitions in the subset of repetitions, or any combination thereof. Accordingly, the repetition-based sensing configuration may be determined according to the parameters indicated in the request as discussed above.

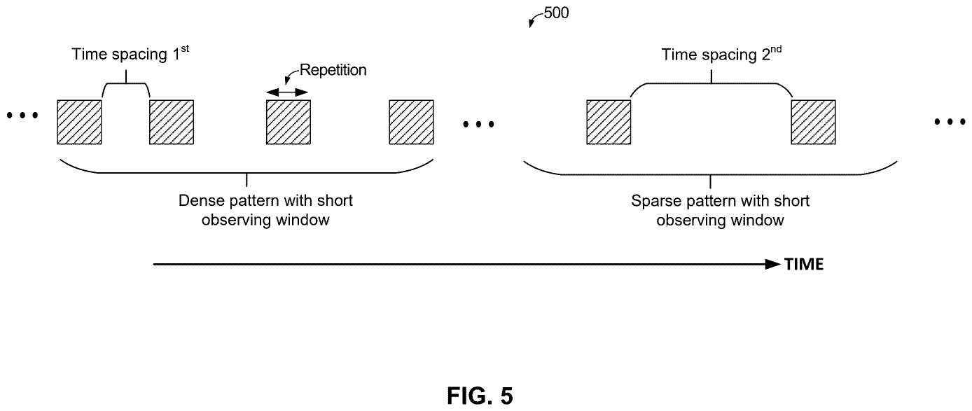

In some embodiments, in accordance with the repetition-based sensing configuration, the time spacings between pairs of neighboring repetitions of the subset of repetitions may be configured differently (e.g., increase towards an end of the RF signal). For example, FIG. 5 is a time diagram illustrating an example slot usage of a RF signal with non-uniform patterned repetitions that may be used by embodiments herein. It is known that when performing the RF sensing, using a configured RF signal having a denser repetition pattern may lead to a smaller latency but a lower Doppler granularity in sensing performance. On the other hand, using a configured RF signal having a sparser repetition pattern for sensing may lead to a larger latency but a higher Doppler granularity for sensing performance. Accordingly, as shown in FIG. 5, at an earlier portion of non-uniform patterned RF signal 500, the subset of repetitions (e.g., the repetitions shown in FIG. 5) may have a dense patten with a short observing window (e.g., the time spacing between pairs of neighboring repetitions is shorter) for having a smaller latency at the early portion of the repetition-based sensing. At a later portion of non-uniform patterned RF signal 500, the subset of repetitions may have a sparse patten with a short observing window (e.g., the time spacing between pairs of neighboring repetitions is longer, e.g., time spacing 2^{nd} is larger than time spacing 1^{st}) for a having higher granularity at the late portion of the repetition-based sensing.

In some embodiments, the non-uniform repetition pattern (e.g., a “front dense behind sparse” pattern) RF signal configuration may be indicated in the repetition-based JSC transmission request. In some embodiments, the time spacings between pairs of neighboring repetitions of the subset of repetitions may be configured according to a linearly increased sequence (e.g., the neighboring repetitions of the subset of repetitions are separated by 3, 4, 5, 6 . . . symbols respectively), an exponentially increased sequence (e.g., the neighboring repetitions of the subset of repetitions are separated by 1, 2, 4, 8 . . . symbols respectively), or any other suitable “front dense behind sparse” sequence.

In some embodiments, in accordance with the repetition-based sensing configuration, to enhance the sensing performance, the correlation for determining the sensing measurements may be determined based on more than two repetitions of the RF signal. For example, more than one repetition with different redundancy versions may be buffered to extract the sensing features (e.g., calculating correlations of repetitions from at least two different groups). In some embodiments, in accordance with the repetition-based sensing configuration, only a portion of the RF signal may be used to calculate the correlation. In some embodiments, when calculating the correlation, two or more repetitions may be jointly used and/or multiple correlations results may be averaged to get a more robust result. In some embodiments, the implementation of the correlation may be determined according to the sensing requirement (e.g., latency, granularity, and/or accuracy).

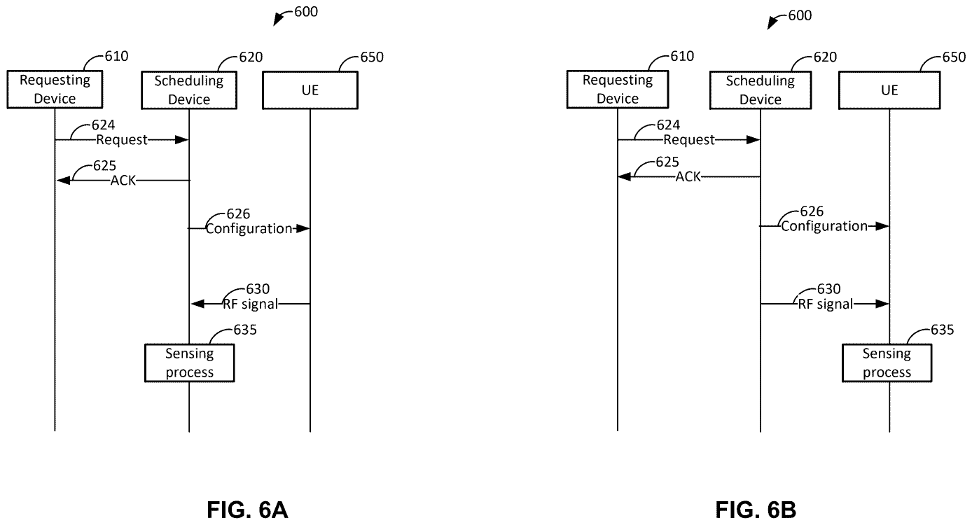

FIGS. 6A-6B are flow diagrams illustrating how repetition-based JSC 600 for sensing a target may be used within a wireless network, according to another embodiment. In some embodiments, repetition-based JSC 600 may be performed between a requesting device 610, a scheduling device 620, and a UE 650. Different from repetition-based JSC 400, in repetition-based JSC 600 requesting device 610 may be a server (e.g., an Operations and Maintenance (O&M) server, a location server, and/or a SMF). The repetition-based JSC transmission may be configured between requesting device 610 and scheduling device 620 and may be performed between scheduling device 620 and UE 650 (discussed in detail below). In some embodiment, requesting device 610 may correspond with network function server 160 of FIG. 1 or any other suitable server and scheduling device 620 may correspond with base stations 120 of FIG. 1. UE 650 may correspond with mobile device 105 of FIG. 1 or UE 205 of FIG. 2.

As shown in FIGS. 6A and 6B, starting at arrow 624, requesting device 610 may send a request for performing the repetition-based JSC transmission to scheduling device 620, indicating a proposed repetition distribution pattern of the subset of repetitions of the RF signals used for sensing (e.g., indicating the granularity or accuracy requirement of the sensing performance). The request for performing the repetition-based JSC transmission may originate from the server (e.g., LMF 220 in FIG. 2), and the repetition-based sensing method may be categorized as being UE assisted (or “network-based”).

At arrow 625, scheduling device 620 may respond with an ACK (e.g., in response to the proposed repetition distribution pattern being supported by scheduling device 620) or a NACK to requesting device 610 (e.g., in response to the proposed repetition distribution pattern not being supported by scheduling device 620).

At arrow 626, responsive to the proposed repetition distribution pattern being supported by scheduling device 620, scheduling device 620 may determine the repetition-based sensing configuration according to the repetition-based JSC transmission request, similar to the repetition-based sensing configuration determination disclosed with respect to FIGS. 4A and 4B and the repetition-based sensing configuration may be transmitted to UE 650 for performing the repetition-based JSC transmission and the sensing.

At arrow 630, a RF signal configured according to the repetition-based sensing configuration may be transmitted between scheduling device 620 and UE 650 for sensing. For example, as shown in FIG. 6A, in PUSCH-based sensing, UE 650 may transmit the RF signal to scheduling device 620. Accordingly, in block 635 shown in FIG. 6A, scheduling device 620 may perform the RF sensing based on the received RF signal (similar to the RF sensing disclosed with respect to FIGS. 4A and 4B). Alternatively, in PDSCH-based sensing, as indicated in FIG. 6B, scheduling device 620 may transmit the RF signal to UE 650. Accordingly, in block 635 shown in FIG. 6B, UE 650 may perform the RF sensing based on the received RF signal (similar to the RF sensing disclosed with respect to FIGS. 4A and 4B).

At block 635, a sensing process may be performed. For example, during the sensing process, as noted above, a transmitting device (e.g., UE 650 in PUSCH-based sensing as shown in FIG. 6A, or scheduling device 620 in PDSCH-based sensing as shown in FIG. 6B) may transmit the RF signals. A receiving device (e.g., scheduling device 620 in PUSCH-based sensing as shown in FIG. 6A, or UE 650 in PDSCH-based sensing as shown in FIG. 6B) may buffer samples of the subset of repetitions indicated in the repetition-based sensing configuration for calculating the correlation of subset of repetitions similar to pulse-based sensing. Reflection or echoes of the RF signals reflected by a target to be sensed may be received by the receiving device, where sensing measurements may be determined based on a correlation of a subset of repetitions of the received RF signals similar to a pulse-based sensing (similar to the RF sensing disclosed with respect to FIGS. 4A and 4B).

In some embodiments, the scheduling device (e.g., scheduling devices 420 or 620) may also be a UE, e.g., an aggressor UE in cross-link inference (CLI) measurement and reporting frameworks. For example, the aggressor UE may send RF signals (e.g., uplink RF signals including a plurality of repetitions for coverage enhancement) to a base station, and the RF signals may be received by another UE (e.g., a victim UE). The RF signals received by the victim UE may be used for the repetition-based sensing as disclosed herein for sensing e.g., the distance between the aggressor UE and the victim UE. In some embodiments, the repetition-based sensing configuration in this scenario may include a CLI received signal strength indicator (RSSI) resource configuration indicating resources included in the subset of repetitions.

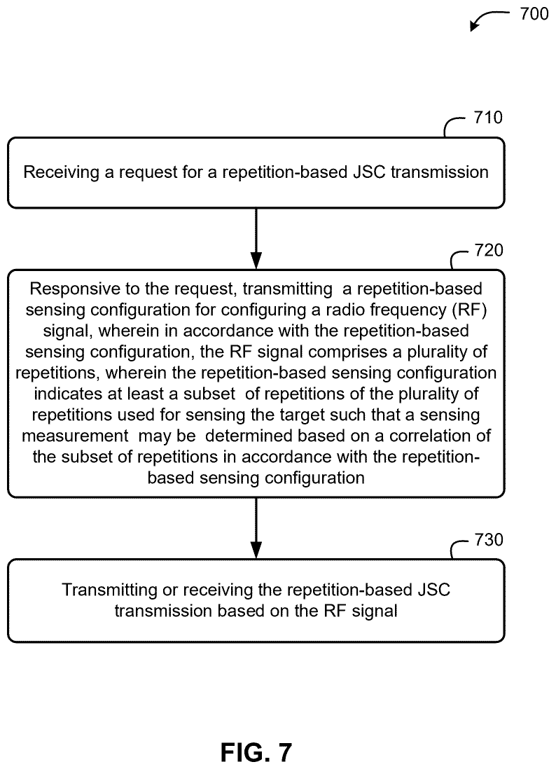

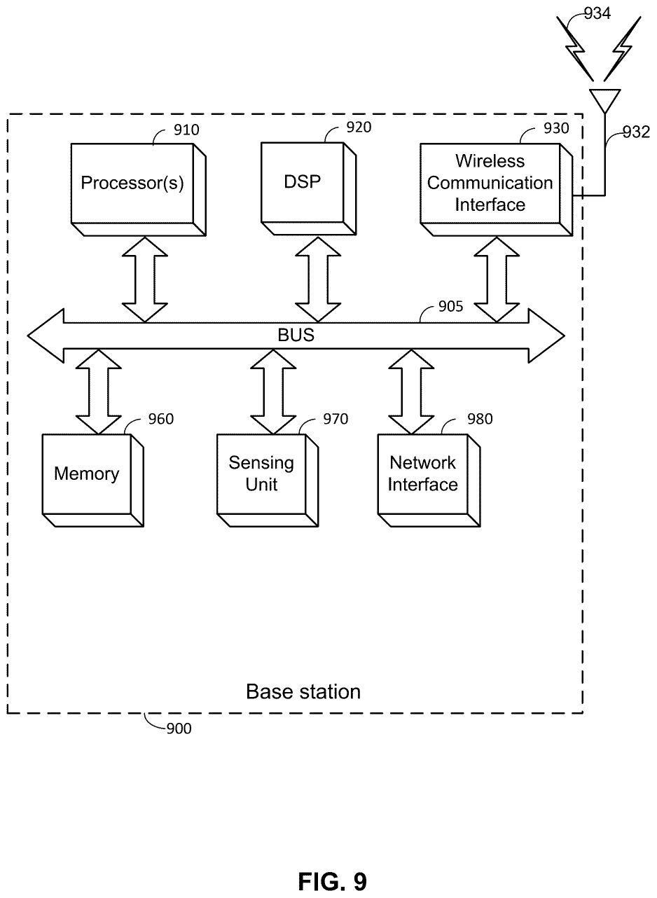

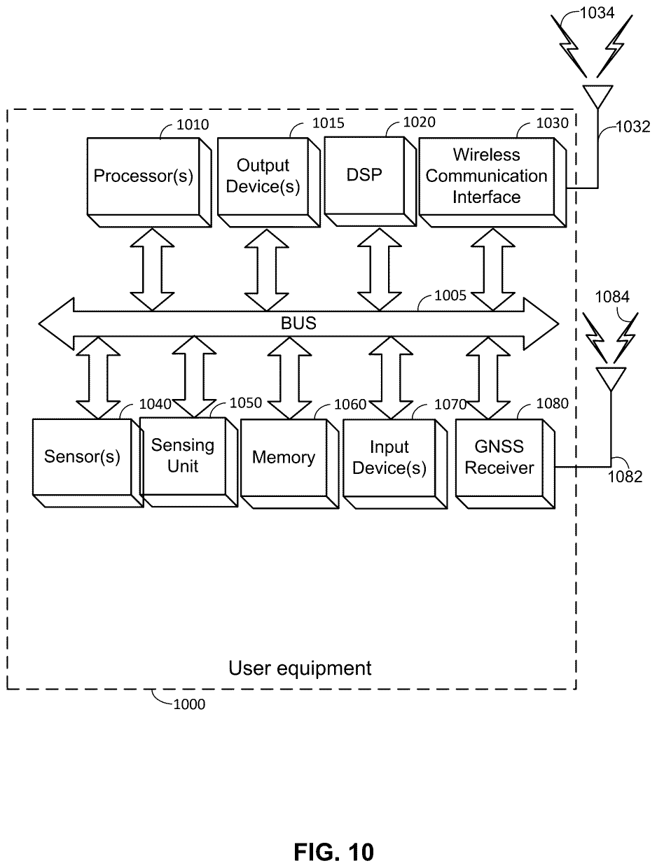

FIG. 7 is a flow diagram of a method 700 of repetition-based joint sensing and communication (JSC) for sensing a target performed by a scheduling device, according to an embodiment. In some embodiments, the scheduling device may correspond to scheduling device 420 in FIG. 4 or scheduling device 620 in FIG. 6. Means/structure for performing the functionality illustrated in one or more of the blocks shown in FIG. 7 may be performed by hardware and/or software components of a base station or a UE (e.g., aggressor UE), as described herein. Example components of a base station are illustrated in FIG. 9 and example components of a UE are illustrated in FIG. 10, which are described in more detail below.

At block 710, the functionality comprises receiving a request for a repetition-based JSC transmission. As illustrated above, in some embodiments, the request for a repetition-based JSC transmission may be transmitted from an UE (e.g., from an application, or “app,” executed by requesting device 410), and the repetition-based sensing may be UE-based. Additionally or alternatively, the request for a repetition-based JSC transmission may originates from the server (e.g., LMF 220 in FIG. 2), and the repetition-based sensing may be categorized as being UE assisted (or “network-based”).

In some embodiments, the request for a repetition-based JSC transmission may indicate a proposed repetition distribution pattern of the subset of repetitions of the RF signals used for sensing (e.g., indicating the granularity or accuracy requirement of the sensing performance).

In some embodiments, the request for a repetition-based JSC transmission may comprise a capability report indicating whether a receiving device (e.g., a device performing the repetition-based JSC transmission with the scheduling device) supports the repetition-based sensing; a maximum length of repetitions that can be buffered by the receiving device; whether to have a phase continuity among the subset of repetitions; or any combination thereof.

In some embodiments, the request for a repetition-based JSC transmission may also indicate a duration of repetitions in the subset of repetitions; a number of repetitions in the subset of repetitions; a redundancy version of repetitions in the subset of repetitions; or any combination thereof.

In some embodiments, if the requesting device comprises a server, method 700 may also include transmitting, to the server, an ACK message in response to the parameters indicated in the request for the repetition-based JSC transmission being supported by the base station, or a NACK message in response to the parameters indicated in the request for the repetition-based JSC transmission not being supported by the base station.

Means for performing functionality at block 710 may comprise a bus 905, processor(s) 910, wireless communication interface 930, memory 960, and/or other components of a base station 900, as illustrated in FIG. 9. Means for performing functionality at block 710 may also comprise a bus 1005, processor(s) 1010, wireless communication interface 1030, memory 1060, and/or other components of a UE 1000, as illustrated in FIG. 10.

At block 720, the functionality comprises responsive to the request, transmitting a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration.

In some embodiments, according to the repetition-based sensing configuration, each repetition of the subset of repetitions of the RF signal may be indexed according to a redundancy version of the respective repetition, wherein repetitions having a same redundancy version are indexed into a same group.

Each repetition of the subset of repetitions may be indexed such that the subset of repetitions may be correlated based on any repetitions of the subset of repetitions; repetitions that belong to the same group; repetitions within a same slot of the RF signal; or any combination thereof when determining the sensing measurements (e.g., TOA measurements and/or phase measurements).

In some embodiments, time spacings between pairs of neighboring repetitions of the subset of repetitions may increase towards an end of the RF signal as discuss in FIG. 5.

In some embodiments, the scheduling device comprises a UE, and wherein the repetition-based sensing configuration comprises a crosslink interferences (CLI) received signal strength indicator (RSSI) resource configuration indicating resources included in the subset of repetitions.

In some embodiments, the repetition-based sensing configuration may be indicated in radio resource control (RRC) signaling, media access control (MAC) control elements, or downlink control information (DCI).

In some embodiments, transmitting the repetition-based sensing configuration may occur prior to a transmission of the plurality of repetitions of the RF signal; prior to a transmission of a repetition used for sensing the target; or any combination thereof.

Means for performing functionality at block 720 may comprise a bus 905, processor(s) 910, wireless communication interface 930, memory 960, and/or other components of a base station 900, as illustrated in FIG. 9. Means for performing functionality at block 720 may also comprise a bus 1005, processor(s) 1010, wireless communication interface 1030, memory 1060, and/or other components of a UE 1000, as illustrated in FIG. 10.

At block 730, the functionality comprises transmitting or receiving the repetition-based JSC transmission based on the RF signal. As discussed above, the sensing of a target may be performed based reflection or echoes of the RF signals reflected by the target. For example, a transmitting device (e.g., requesting device 410 of FIG. 4A, scheduling device 420 of FIG. 4B, UE 650 of FIG. 6A, or scheduling device 620 of FIG. 6B) may transmit the RF signals. Reflection or echoes of the RF signals reflected by the target to be sensed may be received by a receiving device (e.g., scheduling device 420 of FIG. 4A, requesting device 410 of FIG. 4B, scheduling device 620 of FIG. 6A, or UE 650 of FIG. 6B), where sensing measurements may be determined based on a correlation of subset of repetitions of the received RF signals similar to a pulse-based sensing.

Means for performing functionality at block 730 may comprise a bus 905, processor(s) 910, wireless communication interface 930, memory 960, and/or other components of a base station 900, as illustrated in FIG. 9. Means for performing functionality at block 730 may also comprise a bus 1005, processor(s) 1010, wireless communication interface 1030, memory 1060, and/or other components of a UE 1000, as illustrated in FIG. 10.

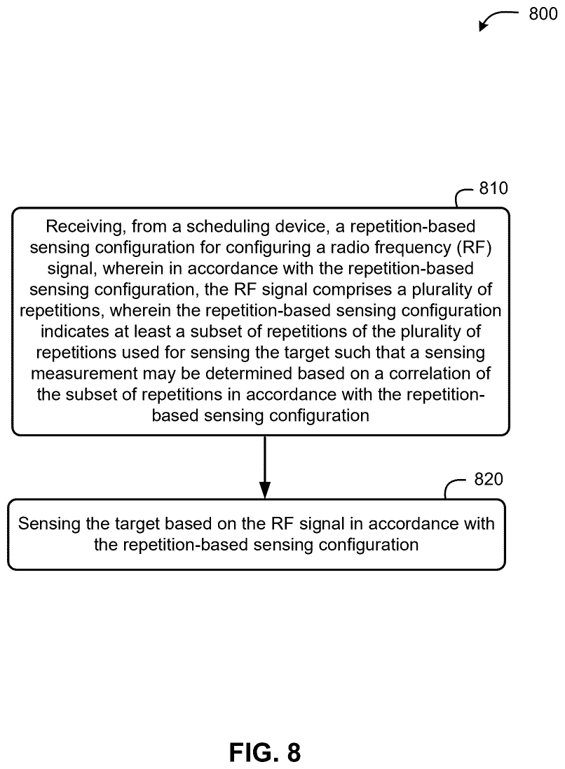

FIG. 8 is a flow diagram of method 800 of repetition-based joint sensing and communication (JSC) for sensing a target performed by a UE, according to an embodiment. In some embodiments, the UE may correspond to requesting device 410 in FIG. 4 or UE 650 in FIG. 6. Means/structure for performing the functionality illustrated in one or more of the blocks shown in FIG. 8 may be performed by hardware and/or software components of a UE, as described herein. Example components of a UE are illustrated in FIG. 10 which are described in more detail below.

At block 810, the functionality comprises receiving, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration.

In some embodiments, method 800 also comprises prior to receiving the repetition-based sensing configuration, transmitting, to the scheduling device, a request for a repetition-based JSC transmission, wherein the repetition-based JSC transmission is performed based on the RF signal configured in accordance with the repetition-based sensing configuration.

In some embodiments, the request for a repetition-based JSC transmission may indicate a proposed repetition distribution pattern of the subset of repetitions of the RF signals used for sensing (e.g., indicating the granularity or accuracy requirement of the sensing performance).

In some embodiments, the request for a repetition-based JSC transmission may comprise a capability report indicating whether the UE (e.g., a device performing the repetition-based JSC transmission with the scheduling device) supports the repetition-based sensing; a maximum length of repetitions that can be buffered by the UE; whether to have a phase continuity among the subset of repetitions; or any combination thereof.

In some embodiments, the request for a repetition-based JSC transmission may also indicate a duration of repetitions in the subset of repetitions; a number of repetitions in the subset of repetitions; a redundancy version of repetitions in the subset of repetitions; or any combination thereof.

Means for performing functionality at block 810 may comprise a bus 1005, processor(s) 1010, wireless communication interface 1030, memory 1060, and/or other components of a UE 1000, as illustrated in FIG. 10.

At block 820, the functionality comprises sensing the target based on the RF signal in accordance with the repetition-based sensing configuration. For example, as noted above, the UE may buffer samples of the subset of repetitions indicated in the repetition-based sensing configuration for calculating the correlation of subset of repetitions similar to a pulse-based sensing. Reflection or echoes of the RF signals reflected by the target to be sensed may be received by the UE, where sensing measurements may be determined based on a correlation of subset of repetitions of the received RF signals similar to a pulse-based sensing.

Means for performing functionality at block 820 may comprise a bus 1005, processor(s) 1010, wireless communication interface 1030, memory 1060, and/or other components of a UE 1000, as illustrated in FIG. 10.

FIG. 9 is a block diagram of an embodiment of a base station 900, which can be utilized as described herein above, with respect to base stations and/or Transmission Reception Point (TRPs). It should be noted that FIG. 9 is meant only to provide a generalized illustration of various components, any or all of which may be utilized as appropriate. In some embodiments, the base station 900 may correspond to a gNB, an ng-eNB, and/or (more generally) a TRP. In some cases, a base station 900 may comprise multiple TRPs—e.g., with each TRP associated with a different antenna or a different antenna array of the base station 900 (e.g., 932). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a base station 900 in earlier-generation networks (e.g., 3G and 4G) may be separated into different functional components (e.g., radio units (Rus), distributed units (Dus), and central units (Cus)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 9.

The base station 900 is shown comprising hardware elements that can be electrically coupled via a bus 905 (or may otherwise be in communication, as appropriate). The hardware elements may include a processor(s) 910 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 9, some embodiments may have a separate DSP 920, depending on desired functionality. Location determination and/or other determinations based on wireless communication may be provided in the processor(s) 910 and/or wireless communication interface 930 (discussed below), according to some embodiments. The base station 900 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 900 might also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 900 to communicate as described herein. The wireless communication interface 930 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 932 that send and/or receive wireless signals 934. According to some embodiments, one or more wireless communication antenna(s) 932 may comprise one or more antenna arrays, which may be capable of beamforming.

Embodiments of the base station 900 may further comprise a sensing unit 970. The sensing unit 970 may comprise hardware and/or software components capable of transmitting and/or receiving RF signals (e.g., RS) to detect one or more targets in the manner described herein. The sensing unit 970 may comprise a standalone component connected with a bus 905, as illustrated, or may be incorporated into another component (e.g., the wireless communication interface 930). Further, the sensing unit 970 may be communicatively coupled with an antenna 932, which it may share with the wireless communication interface 930. Additionally or alternatively, the sensing unit 970 may have its own antenna (not shown). In some embodiments the sensing unit 970 may be communicatively coupled with multiple antennas or an antenna array capable of sending and/or receiving RF signals via directional beams.

The base station 900 may also include a network interface 980, which can include support of wireline communication technologies. The network interface 980 may include a modem, network card, chipset, and/or the like. The network interface 980 may include one or more input and/or output communication interfaces to permit data to be exchanged with a network, communication network servers, computer systems, and/or any other electronic devices described herein.

In many embodiments, the base station 900 may further comprise a memory 960. The memory 960 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the base station 900 also may comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the base station 900 (and/or processor(s) 910 or DSP 920 within base station 900). In some embodiments, then, such code and/or instructions can be used to configure and/or adapt a general-purpose computer (or other device) to perform one or more operations in accordance with the described methods.

FIG. 10 is a block diagram of an embodiment of a UE 1000, which can be utilized as described herein (e.g., in association with the previously described figures). In some embodiments, for example, the UE 1000 may comprise, for example, a mobile (e.g., movable/portable) device (e.g., tablet, laptop, vehicle, etc.). It should be noted that FIG. 10 is meant only to provide a generalized illustration of various components, any or all of which may be utilized as appropriate.

The UE 1000 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple Ics. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The UE 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 1000 to communicate with other devices as described in the embodiments above. The wireless communication interface 1030 may permit data and signaling to be communicated (e.g., transmitted and received) with base stations of a network, for example, via eNBs, gNBs, ng-eNBs, access points, various base stations and/or other access node types, and/or other network components, computer systems, and/or any other electronic devices communicatively coupled with base stations, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 1000 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3^{rd} Generation Partnership Project (3GPP). CDMA2000® is described in documents from a consortium named “3^{rd} Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 1000 may further comprise a sensing unit 1050. The sensing unit 1050 may comprise hardware and/or software components capable of transmitting and/or receiving RF signals (e.g., RS) to detect one or more targets in the manner described herein. The sensing unit 1050 may comprise a standalone component connected with a bus 1005, as illustrated, or may be incorporated into another component (e.g., the wireless indication interface 1030). Further, the sensing unit 1050 may be communicatively coupled with an antenna 1032, which it may share with the wireless communication interface 1030. Additionally or alternatively, the sensing unit 1050 may have its own antenna (not shown). In some embodiments the sensing unit 1050 may be communicatively coupled with multiple antennas or an antenna array capable of sending and/or receiving RF signals via directional beams.

Embodiments of the UE 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 1000, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1010 or DSP 1020.

The UE 1000 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 1000 (and/or processor(s) 1010 or DSP 1020 within UE 1000). In some embodiments, then, such code and/or instructions can be used to configure and/or adapt a general-purpose computer (or other device) to perform one or more operations in accordance with the described methods.

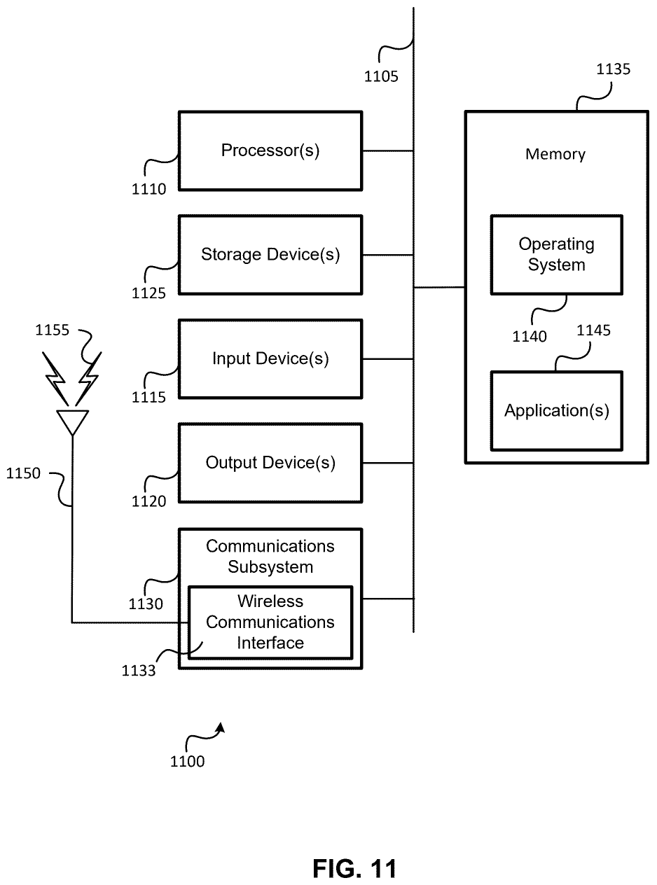

FIG. 11 is a block diagram of an embodiment of a computer system 1100, which may be used, in whole or in part, to provide the functions of one or more components and/or devices as described in the embodiments herein, including a server (e.g., sensing server/SMF, location server/LMF, etc.) in communication with one or more base stations and/or one or more sensing nodes to coordinate RF sensing as described in embodiments herein. This may include, for example, a computer server, personal computer, personal electronic device, or the like. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner. In addition, it can be noted that components illustrated by FIG. 11 can be localized to a single device and/or distributed among various networked devices, which may be disposed at different geographical locations.

The computer system 1100 is shown comprising hardware elements that can be electrically coupled via a bus 1105 (or may otherwise be in communication, as appropriate). The hardware elements may include processor(s) 1110, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1100 also may comprise one or more input devices 1115, which may comprise without limitation a mouse, a keyboard, a camera, a microphone, and/or the like; and one or more output devices 1120, which may comprise without limitation a display device, a printer, and/or the like.

The computer system 1100 may further include (and/or be in communication with) one or more non-transitory storage devices 1125, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1100 may also include a communications subsystem 1130, which may comprise wireless communication technologies managed and controlled by a wireless communication interface 1133, as well as wired technologies (such as Ethernet, coaxial communications, universal serial bus (USB), and the like). The wireless communication interface 1133 may comprise one or more wireless transceivers that may send and receive wireless signals 1155 (e.g., signals according to 5G NR or LTE) via wireless antenna(s) 1150. Thus the communications subsystem 1130 may comprise a modem, a network card (wireless or wired), an infrared communication device, a wireless communication device, and/or a chipset, and/or the like, which may enable the computer system 1100 to communicate on any or all of the communication networks described herein to any device on the respective network, including a User Equipment (UE), base stations and/or other transmission reception points (TRPs), and/or any other electronic devices described herein. Hence, the communications subsystem 1130 may be used to receive and send data as described in the embodiments herein.

In many embodiments, the computer system 1100 will further comprise a working memory 1135, which may comprise a RAM or ROM device, as described above. Software elements, shown as being located within the working memory 1135, may comprise an operating system 1140, device drivers, executable libraries, and/or other code, such as one or more applications 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1125 described above. In some cases, the storage medium might be incorporated within a computer system, such as computer system 1100. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of repetition-based joint sensing and communication (JSC) for sensing a target performed by a scheduling device may comprise receiving a request for a repetition-based JSC transmission. The method may also comprise responsive to the request, transmitting a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The method may further comprise transmitting or receiving the repetition-based JSC transmission based on the RF signal.

Clause 2. The method of the clause 1, wherein the repetition-based sensing configuration is indicated in radio resource control (RRC) signaling, media access control (MAC) control elements, or downlink control information.

Clause 3. The method of any of clause 1 or 2, wherein each repetition of the subset of repetitions of the RF signal is indexed according to a redundancy version of the respective repetition, wherein repetitions having a same redundancy version are indexed into a same group.

Clause 4. The method of any of clauses 1-3, wherein each repetition of the subset of repetitions is indexed such that the subset of repetitions may be correlated based on: any repetitions of the subset of repetitions; repetitions that belong to the same group; repetitions within a same slot of the RF signal; or any combination thereof.

Clause 5. The method of any of clauses 1-4, wherein transmitting the repetition-based sensing configuration occurs: prior to a transmission of the plurality of repetitions of the RF signal; prior to a transmission of a repetition used for sensing the target; or any combination thereof.

Clause 6. The method of any of clauses 1-5, wherein the repetition-based sensing configuration comprises a negative acknowledgment message (NACK) indicating that at least one repetition belongs to the subset of the repetitions.

Clause 7. The method of any of clauses 1-6, further comprising: receiving, from a receiving device performing the repetition-based JSC transmission with the scheduling device, a capability report indicating: whether the receiving device supports the repetition-based sensing; a maximum length of repetitions that can be buffered by the receiving device; whether to have a phase continuity among the subset of repetitions; or any combination thereof.

Clause 8. The method of any of clauses 1-7, wherein the scheduling device comprises a base station, and wherein the request for the repetition-based JSC transmission indicates a proposed repetition distribution pattern of the subset of repetitions.

Clause 9. The method of any of clauses 1-8, wherein the request for the repetition-based JSC transmission further includes parameters indicating: a duration of repetitions in the subset of repetitions; a number of repetitions in the subset of repetitions; a redundancy version of repetitions in the subset of repetitions; or any combination thereof.

Clause 10. The method of any of clauses 1-9, further comprising: transmitting, to a server, an acknowledgement (ACK) message in response to the parameters indicated in the request for the repetition-based JSC transmission being supported by the base station.

Clause 11. The method of any of clauses 1-10, wherein time spacings between pairs of neighboring repetitions of the subset of repetitions increase towards an end of the RF signal.

Clause 12. The method of any of clauses 1-11, wherein the scheduling device comprises a UE, and wherein the repetition-based sensing configuration comprises a crosslink interferences (CLI) received signal strength indicator (RSSI) resource configuration indicating resources included in the subset of repetitions.

Clause 13. The method of any of clauses 1-12, wherein the correlation is determined based on more than two repetitions of the RF signal.

Clause 14. A method of repetition-based joint sensing and communication (JSC) for sensing a target performed by a UE may comprise receiving, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The method may also comprise sensing the target based on the RF signal in accordance with the repetition-based sensing configuration.

Clause 15. The method of the clause 14, further comprising: receiving the repetition-based sensing configuration based on radio resource control (RRC) signaling, media access control (MAC) control elements, or downlink control information.

Clause 16. The method of any of clause 14 or 15, wherein each repetition of the subset of repetitions of the RF signal is indexed according to a redundancy version of the respective repetition, wherein repetitions having a same redundancy version are indexed into a same group.

Clause 17. The method of any of clauses 14-16, further comprising: prior to receiving the repetition-based sensing configuration, transmitting, to the scheduling device, a request for a repetition-based JSC transmission, wherein the repetition-based JSC transmission is performed based on the RF signal configured in accordance with the repetition-based sensing configuration.

Clause 18. The method of any of clauses 14-17, wherein the request for the repetition-based JSC transmission further comprises a capability report indicating: whether the UE supports the repetition-based sensing; a maximum length of repetitions that can be buffered by the UE; whether to have a phase continuity among the subset of repetitions; or any combination thereof.

Clause 19. The method of any of clauses 14-18, wherein the request for the repetition-based JSC transmission indicates a proposed repetition distribution pattern of the subset of repetitions.

Clause 20. The method of any of clauses 14-19, wherein the request for the repetition-based JSC transmission further includes parameters indicating: a duration of repetitions in the subset of repetitions; a number of repetitions in the subset of repetitions; a redundancy version of repetitions in the subset of repetitions; or any combination thereof.

Clause 21. A scheduling device for repetition-based joint sensing and communication (JSC) for sensing a target comprise a transceiver; a memory; and one or more processors communicatively coupled with the transceiver and the memory. The one or more processors may be configured to receive a request for a repetition-based JSC transmission. The one or more processors may also be configured to responsive to the request, transmit a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The one or more processors may further be configured to transmit or receive the repetition-based JSC transmission based on the RF signal.

Clause 22. The scheduling device of clause 21, wherein the repetition-based sensing configuration is indicated in radio resource control (RRC) signaling, media access control (MAC) control elements, or downlink control information.

Clause 23. The scheduling device of any of clause 21 or 22, wherein each repetition of the subset of repetitions of the RF signal is indexed according to a redundancy version of the respective repetition, wherein repetitions having a same redundancy version are indexed into a same group.

Clause 24. The scheduling device of any of clauses 21-23, wherein each repetition of the subset of repetitions is indexed such that the subset of repetitions may be correlated based on: any repetitions of the subset of repetitions; repetitions that belong to the same group; repetitions within a same slot of the RF signal; or any combination thereof.

Clause 25. The scheduling device of any of clauses 21-24, wherein the one or more processors transmit the repetition-based sensing configuration: prior to a transmission of the plurality of repetitions of the RF signal; prior to a transmission of a repetition used for sensing the target; or any combination thereof.

Clause 26. The scheduling device of any of clauses 21-25, wherein the repetition-based sensing configuration comprises a negative acknowledgment message (NACK) indicating that at least one repetition belongs to the subset of the repetitions.

Clause 27. The scheduling device of any of clauses 21-26, wherein the one or more processors are further configured to: receive, from a receiving device performing the repetition-based JSC transmission with the scheduling device, a capability report indicating: whether the receiving device supports the repetition-based sensing; a maximum length of repetitions that can be buffered by the receiving device; whether to have a phase continuity among the subset of repetitions; or any combination thereof.

Clause 28. The scheduling device of any of clauses 21-27, wherein the scheduling device comprises a base station, and wherein the request for the repetition-based JSC transmission indicates a proposed repetition distribution pattern of the subset of repetitions.

Clause 29. The scheduling device of any of clauses 21-28, wherein the request for the repetition-based JSC transmission further includes parameters indicating: a duration of repetitions in the subset of repetitions; a number of repetitions in the subset of repetitions; a redundancy version of repetitions in the subset of repetitions; or any combination thereof.

Clause 30. An example UE for repetition-based joint sensing and communication (JSC) for sensing a target comprise a transceiver; a memory; and one or more processors communicatively coupled with the transceiver and the memory. The one or more processors may be configured to receive, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration. The one or more processors may also be configured to sense the target based on the RF signal in accordance with the repetition-based sensing configuration.

1-13. (canceled)

14. A method of repetition-based joint sensing and communication (JSC) for sensing a target performed by a user equipment (UE), the method comprising:
receiving, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration; and
sensing the target based on the RF signal in accordance with the repetition-based sensing configuration.

15. The method of claim 14, further comprising:
receiving the repetition-based sensing configuration based on radio resource control (RRC) signaling, media access control (MAC) control elements, or downlink control information.

16. The method of claim 14, wherein each repetition of the subset of repetitions of the RF signal is indexed according to a redundancy version of the respective repetition, wherein repetitions having a same redundancy version are indexed into a same group.

17. The method of claim 14, further comprising:
prior to receiving the repetition-based sensing configuration, transmitting, to the scheduling device, a request for a repetition-based JSC transmission, wherein the repetition-based JSC transmission is performed based on the RF signal configured in accordance with the repetition-based sensing configuration.

18. The method of claim 17, wherein the request for the repetition-based JSC transmission indicates a proposed repetition distribution pattern of the subset of repetitions, or further comprises a capability report indicating:
whether the UE supports the repetition-based sensing;
a maximum length of repetitions that can be buffered by the UE;
whether to have a phase continuity among the subset of repetitions; or
any combination thereof.

19. (canceled)

20. The method of claim 19, wherein the request for the repetition-based JSC transmission further includes parameters indicating:
a duration of repetitions in the subset of repetitions;
a number of repetitions in the subset of repetitions;
a redundancy version of repetitions in the subset of repetitions; or
any combination thereof.

21. A scheduling device for repetition-based joint sensing and communication (JSC) for sensing a target, the device comprising:
a transceiver;
a memory; and
one or more processors communicatively coupled with the transceiver and the memory, wherein the one or more processors are configured to:
receive a request for a repetition-based JSC transmission;
responsive to the request, transmit a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration; and
transmit or receive the repetition-based JSC transmission based on the RF signal.

22. The device of claim 21, wherein the repetition-based sensing configuration is indicated in radio resource control (RRC) signaling, media access control (MAC) control elements, or downlink control information.

23. The device of claim 21, wherein each repetition of the subset of repetitions of the RF signal is indexed according to a redundancy version of the respective repetition, wherein repetitions having a same redundancy version are indexed into a same group.

24. The device of claim 23, wherein each repetition of the subset of repetitions is indexed such that the subset of repetitions may be correlated based on:
any repetitions of the subset of repetitions;
repetitions that belong to the same group;
repetitions within a same slot of the RF signal; or
any combination thereof.

25. The device of claim 21, wherein the one or more processors transmit the repetition-based sensing configuration:
prior to a transmission of the plurality of repetitions of the RF signal;
prior to a transmission of a repetition used for sensing the target; or
any combination thereof.

26. The device of claim 21, wherein the repetition-based sensing configuration comprises a negative acknowledgment message (NACK) indicating that at least one repetition belongs to the subset of the repetitions.

27. The device of claim 21, wherein the one or more processors are further configured to:
receive, from a receiving device performing the repetition-based JSC transmission with the scheduling device, a capability report indicating:
whether the receiving device supports the repetition-based sensing;
a maximum length of repetitions that can be buffered by the receiving device;
whether to have a phase continuity among the subset of repetitions; or
any combination thereof.

28. The device of claim 21, wherein the scheduling device comprises a base station, and wherein the request for the repetition-based JSC transmission indicates a proposed repetition distribution pattern of the subset of repetitions.

29. The device of claim 28, wherein the request for the repetition-based JSC transmission further includes parameters indicating:
a duration of repetitions in the subset of repetitions;
a number of repetitions in the subset of repetitions;
a redundancy version of repetitions in the subset of repetitions; or
any combination thereof.

30. A user equipment (UE) for repetition-based joint sensing and communication (JSC) for sensing a target, the UE comprising:
a transceiver;
a memory; and
one or more processors communicatively coupled with the transceiver and the memory, wherein the one or more processors are configured to:
receive, from a scheduling device, a repetition-based sensing configuration for configuring a radio frequency (RF) signal, wherein in accordance with the repetition-based sensing configuration, the RF signal comprises a plurality of repetitions, wherein the repetition-based sensing configuration indicates at least a subset of repetitions of the plurality of repetitions used for sensing the target such that a sensing measurement may be determined based on a correlation of the subset of repetitions in accordance with the repetition-based sensing configuration; and
sense the target based on the RF signal in accordance with the repetition-based sensing configuration.

31. The device of claim 29, wherein the one or more processors are further configured to:
transmit, to a server, an acknowledgement (ACK) message in response to the parameters indicated in the request for the repetition-based JSC transmission being supported by the base station.

32. The device of claim 21, wherein time spacings between pairs of neighboring repetitions of the subset of repetitions increase towards an end of the RF signal.

33. The device of claim 21, wherein the scheduling device comprises a UE, and wherein the repetition-based sensing configuration comprises a crosslink interferences (CLI) received signal strength indicator (RSSI) resource configuration indicating resources included in the subset of repetitions.

34. The device of claim 21, wherein the correlation is determined based on more than two repetitions of the RF signal.
